(19) United States
(12) Patent Application Publication
(10) Pub. No.: US 2015/0149264 A1
(43) Pub. Date: May 28, 2015

(54) METHOD AND SYSTEM FOR GENERATING PARKING METER ALERT NOTIFICATIONS

(71) Applicant: MasterCard International Incorporated, Purchase, NY (US)

(72) Inventors: Kenny UNSER, Fairfield, CT (US); Serge Bernard, Danbury, CT (US); Nikhil Malgatti, Stamford, CT (US)

(73) Assignee: MasterCard International Incorporated, Purchase, NY (US)

(21) Appl. No.: 14/090,616

(22) Filed: Nov. 26, 2013

(51) Int. Cl. G06Q 30/02; G07B 15/02

(52) U.S. Cl. CPC G06Q 30/0284; G07B 15/02
USPC 705/13

(57) ABSTRACT

A method for providing parking meter alert notifications includes: storing a plurality of parking rate data entries, each entry including data related to a parking meter including at least a point of sale identifier associated with the related parking meter and a timing rate; receiving transaction data for a payment transaction associated with a specific parking meter, wherein the transaction data includes at least a specific consumer identifier, a transaction amount, a specific point of sale identifier associated with the specific parking meter, and a transaction time; identifying a specific parking rate data entry where the included point of sale identifier corresponds to the specific point of sale identifier; identifying an expiration time based on the transaction time, the transaction amount, and the timing rate included in the identified specific parking rate data entry; and transmitting an alert notification to a consumer based on the specific consumer identifier.

### FIELD

The present disclosure relates to the providing of parking meter alert notifications, specifically the transmitting of an alert to a consumer regarding an expiring parking meter that is initiated by use of a payment card to pay for the parking meter.

### BACKGROUND

Many cities and municipalities use parking meters as a way to both manage parking in a specific location and gain additional income. In many instances, parking meters operate by requiring consumers to pay a specific amount for a specific length of time, such that, to remain parked for beyond the length of time, additional payment may be required. In such instances, if a car is left parked at a meter once the paid-for length of time has expired, the consumer may receive a citation and the car may be rendered inoperable or towed. As a result, consumers have developed methods for remembering when they need to return to their car, move their car, or add additional time to their meter via additional payment.

In many instances, consumers may simply identify the expiration time of their parking meter and make a mental note of the time. As cellular phones, smartphones and other mobile computing devices have become widespread in their use, many consumers utilize alarm or timer functions provided by such devices to remind themselves of the expiration of their paid-for parking time, and some apps have geolocation functions to reminder the consumer of the car's location. However, such a method may require a consumer to identify the amount of their payment and the rate for the parking meter, calculate the amount of parking time purchased, and then identify the expiration time based on the time at which the payment was made or at least input the remaining time if that is displayed on the meter. Then, the consumer must set an alarm for the expiration time on their device. Such a process may be cumbersome and/or difficult for a number of consumers, especially consumers in an unfamiliar location or are in a hurry.

One parking system that has been developed enables a consumer to use a mobile device to pay for parking via an application program. Once the consumer provides payment, the system identifies the expiration time and may provide for notices to the consumer of their remaining parking time. However, such a system may require the consumer to first register for the system, provide payment details to the system, identify the parking meter or area in which they parked, and then submit the payment. In many instances, the consumer may be unwilling to share their payment details with such a system, unwilling to register with such a system, or may simply be in too much of a hurry to perform all of the steps necessary to register with the system prior to paying for parking.

Thus, the present inventors believe there is a need for a technical system to provide for parking meter alert notifications to consumers that does not require a time-consuming registration and payment process in order to receive the alert notifications.

### SUMMARY

The present disclosure provides a description of systems and methods for providing parking meter alert notifications.

A method for providing parking meter alert notifications includes: storing, in a meter database, a plurality of parking rate data entries, wherein each parking rate data entry includes data related to a parking meter including at least a point of sale identifier associated with the related parking meter and a timing rate; receiving, by a receiving device, transaction data for a payment transaction associated with a specific parking meter, wherein the transaction data includes at least a specific consumer identifier, a transaction amount, a specific point of sale identifier associated with the specific parking meter, and a transaction time and/or date; identifying, in the meter database, a specific parking rate data entry where the included point of sale identifier corresponds to the specific point of sale identifier; identifying, by a processing device, an expiration time and/or date based on the transaction time and/or date, the transaction amount, and the timing rate included in the identified specific parking rate data entry; and transmitting, by a transmitting device, an alert notification to a consumer based on the specific consumer identifier.

Another method for providing parking meter alert notifications includes: receiving, by a receiving device, transaction data for a payment transaction associated with a specific parking meter, wherein the transaction data includes at least a specific consumer identifier, a transaction amount, a transaction time and/or date, and rate data; identifying, by a processing device, an expiration time and/or date based on at least the transaction time and/or date and the rate data included in the received transaction data; and transmitting, by a transmitting device, an alert notification to a consumer based on the specific consumer identifier.

A system for providing parking meter alert notifications includes a meter database, a receiving device, a processing device, and a transmitting device. The meter database is configured to store a plurality of parking rate data entries, wherein each parking rate data entry includes data related to a parking meter including at least a point of sale identifier associated with the related parking meter and a timing rate. The receiving device is configured to receive transaction data for a payment transaction associated with a specific parking meter, wherein the transaction data includes at least a specific consumer identifier, a transaction amount, a specific point of sale identifier associated with the specific parking meter, and a transaction time and/or date. The processing device is configured to: identify, in the meter database, a specific parking rate data entry where the included point of sale identifier corresponds to the specific point of sale identifier; and identify an expiration time and/or date based on the transaction time and/or date, the transaction amount, and the timing rate included in the identified specific parking rate data entry. The transmitting device is configured to transmit an alert notification to a consumer based on the specific consumer identifier.

Another system for providing parking meter alert notifications includes a receiving device, a processing device, and a transmitting device. The receiving device is configured to receive transaction data for a payment transaction associated with a specific parking meter, wherein the transaction data includes at least a specific consumer identifier, a transaction amount, a transaction time and/or date, and rate data. The processing device is configured to identify an expiration time and/or date based on at least the transaction time and/or date and the rate data included in the received transaction data. The transmitting device is configured to transmit an alert notification to a consumer based on the specific consumer identifier.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system providing parking meter alert notifications in accordance with exemplary embodiments.

FIG. 2 is a block diagram illustrating the processing server of FIG. 1 for the providing of parking meter alert notifications in accordance with exemplary embodiments.

FIGS. 3 and 4 are flow diagrams illustrating processes for providing a parking meter alert notification using the system of FIG. 1 in accordance with exemplary embodiments.

FIG. 5 is a flow diagram illustrating a method for providing parking meter alert notifications using the processing server of FIG. 2 in accordance with exemplary embodiments.

FIGS. 6 and 7 are flow charts illustrating exemplary methods for providing parking meter alert notifications in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

### System for Providing Parking Meter Alert Notifications

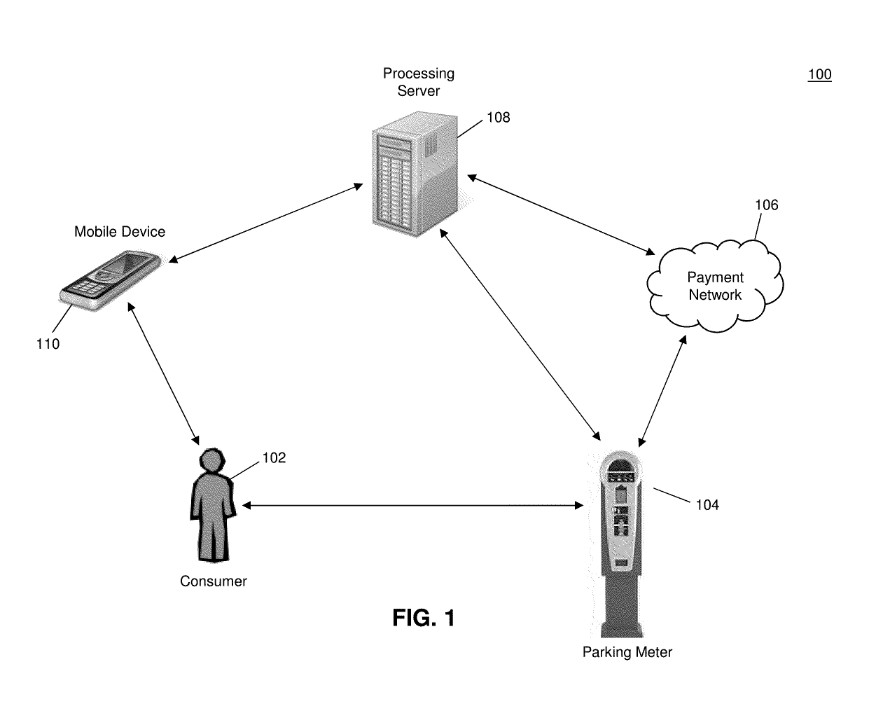

FIG. 1 illustrates a system 100 for the providing of parking meter alert notifications to consumers based on transaction data.

The system 100 may include a consumer 102. The consumer 102 may park a vehicle in a parking space or in a designated parking area where payment is required to park. The consumer 102 may then provide payment for the parking to a parking meter 104. The parking meter 104 may be a device, kiosk, stand, or other similar parking payment structure configured to accept payment for parking. The consumer 102 may pay for the parking using a payment card.

In some embodiments, the parking meter 104 may read payment details encoded in a magnetic stripe of the payment card using systems and methods that will be apparent to persons having skill in the relevant art. In other embodiments, the consumer 102 may present a mobile device 110 for payment. For example, the mobile device 110 may transmit payment details to the parking meter 104 via near field communication, a machine-readable code encoded with payment details, or other suitable method as will be apparent to persons having skill in the relevant art. In some instances, the mobile device 110 may include a wallet application program for use in conveying the payment details to the parking meter 104. The mobile device 110 may be a cellular phone, smart phone, tablet computer, laptop computer, or other suitable device as will be apparent to persons having skill in the relevant art.

Once the parking meter 104 has received the payment details from the consumer 102, the parking meter 104 may generate and submit an authorization request for a payment transaction for the parking to a payment network 106 for processing. In some instances, the parking meter 104 may transmit data associated with the transaction to an acquirer, which may generate and submit the authorization request to the payment network 106 on behalf of the parking meter 104. The payment network 106 may then process the payment transaction using methods and systems that will be apparent to persons having skill in the relevant art, which may include transmitting an authorization response indicating approval of the transaction to the parking meter 104.

Once the parking meter 104 has received the authorization response indicating approval, the parking meter 104 may display to the consumer 102 that the payment was successful and may provide the consumer 102 with information regarding their parking time and expiration of the parking time. The consumer 102 may then go about their business and return to the parking space or area prior to the expiration time to add additional time via additional payment or leave.

The system may further include a processing server 108. The processing server 108, discussed in more detail below, may be configured to provide parking meter alert notifications to the consumer 102 via their mobile device 110. In some embodiments, the processing server 108 may be included in or operated by the payment network 106 and/or an entity associated with the parking meter 104. Once the payment transaction for the parking has been processed, the payment network 106 and/or the parking meter 104 may transmit transaction data associated with the payment transaction to the processing server 108. As discussed in more detail below, the transaction data may include at least a consumer identifier, a transaction amount, a point of sale identifier, and a transaction time and/or date.

The processing server 108 may then identify rate data for the parking meter 104. The processing server 108 may calculate an expiration time based on the rate data and the transaction amount paid by the consumer 102. Once the expiration time has been calculated, the processing server 108 may transmit an alert notification to the mobile device 110 of the consumer 102. In some instances, the processing server 108 may transmit the alert notification at one or more predetermined times prior to the expiration time. For example, the processing server 108 may transmit alerts thirty minutes, fifteen minutes, and five minutes prior to the expiration, or a time period based on the distance between the mobile device 110 of the consumer 102 and the parking meter 104 either pinned by the consumer 102 when at the parking meter 104 on his or her geographic location determination enabled mobile device 110, or via the processing server 108.

That is, in some embodiments, the processing server 108 may identify the geographic location of the parking meter 104. In such an embodiment, the processing server 108 may include the geographic location of the parking meter 104 in the alert notification. The consumer 102 may then more easily find where they parked their car as a result of having the geographic location of the parking meter 104 provided to them along with their alert as to the expiration time.

The system 100 may provide for the providing of parking meter alert notifications to the mobile device 110 of the consumer 102 by the processing server 108, using transaction data for a payment transaction for the purchase of the parking, without requiring the consumer 102 to register for a service or provide any additional information. As a result, the consumer 102 may simply pay for parking with their payment card, and then automatically receive parking meter alert notifications from the processing server 108. Such a system may require significantly less actions to be performed by the consumer 102, and thus be more efficient and also more effective for consumers 102.

### Processing Server

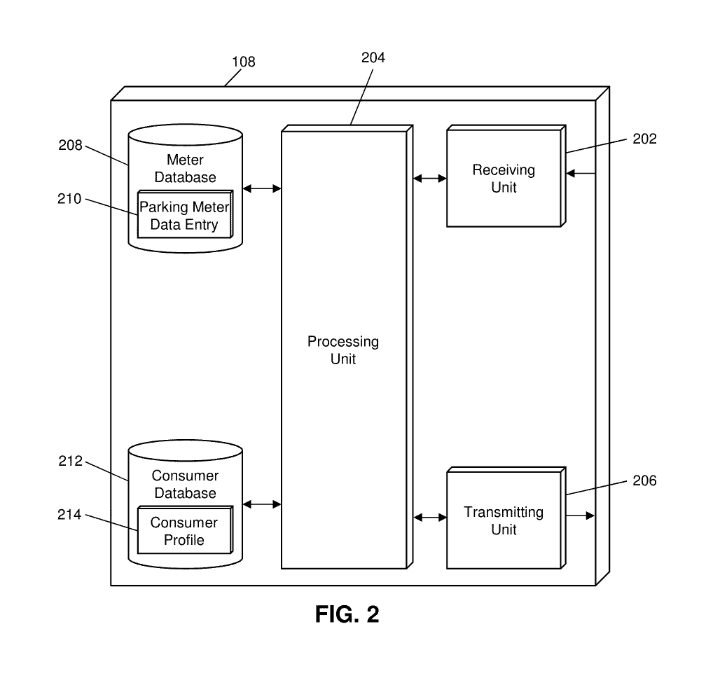

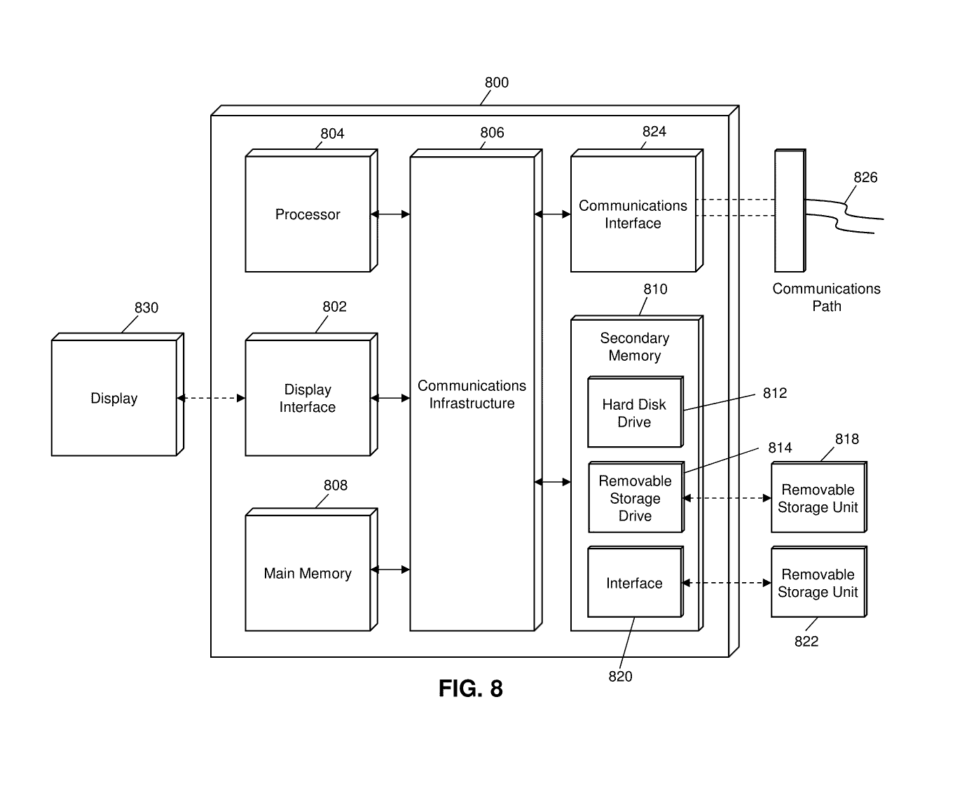

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 800 illustrated in FIG. 8 and discussed in more detail below may be a suitable configuration of the processing server 108.

The processing server 108 may include a meter database 208. The meter database 208 may be configured to store a plurality of parking meter data entries 210. Each parking meter data entry 210 may include data related to a parking meter 104 including at least a point of sale identifier associated with the related parking meter 104 and a timing rate. The point of sale identifier may be a unique value suitable for use in identifying the respective parking meter data entry 210 and/or the related parking meter 104, such as an identification number, registration number, serial number, media access control address, Internet protocol address, or other suitable value as will be apparent to persons having skill in the relevant art.

The timing rate may be the rate at which parking time is gained based on payment provided by the consumer 102. For example, the timing rate may be five minutes per twenty-five cents, thirty minutes for one dollar, etc. The timing rate may be provided by the parking meter 104 or an entity owning and/or operating the parking meter 104, or may be identified by the processing server 108. In one example, the processing server 108 may identify the timing rate for a parking meter 104 based on transactions conducted involving the parking meter 104. In such an example, the processing server 108 may identify instances where consumers 102 paid for parking a second time at the same parking meter 104, and identify the timing rate based on time elapsed between the first payment and second payment. In another example, the processing server 108 may identify a timing rate based on crowd sourced data, such as data provided by consumers 102. For instance, once a transaction is initiated, the mobile device 110 might display an enquiry or an estimate of time with a request for input correction of the meter time and/or rate by the customer 102.

In some embodiments, each parking meter data entry 210 may further include a geographic location of the related parking meter 104. The geographic location may be represented by latitude and longitude, a street address, and/or any other value suitable for use by the consumer 102 in identifying the location of the parking meter 104. In one embodiment, the point of sale identifier may be the geographic location associated with the related parking meter 104. In such an embodiment, parking meters 104 may accordingly be identified based on their geographic location.

The processing server 108 may further include a consumer database 212. The consumer database 212 may include a plurality of consumer profiles 214. Each consumer profile 214 may include data related to a consumer 102 including at least a consumer identifier and a device identifier. The consumer identifier may be a unique value suitable for identifying the consumer profile 214 and/or the related consumer 102, such as an identification number, payment account number corresponding to a payment account associated with the related consumer 102, etc.

The device identifier may be a unique value associated with the mobile device 110 suitable for identification of the mobile device 110, such as a media access control address, e-mail address, phone number, identification number, registration number, serial number, etc. In some embodiments, the device identifier and the consumer identifier may be the same value. For example, the consumer identifier and device identifier may be an e-mail address. In some instances, the device identifier may be a value suitable for use by the processing server 108 in transmitting the parking meter alert notifications to the mobile device 110, such as an e-mail address or phone number.

In some embodiments, the consumer profile 214 may further include a preferred method of distribution and/or distribution data. The distribution data may include contact information for the distribution of the parking meter alert notifications to the mobile device 110. The preferred method of distribution may be the preferred method of the consumer 102 to be used to distribute parking meter alert notifications to the mobile device 110, such as e-mail, short message service message, multimedia message service message, an application program executed on the mobile device 110, etc.

The processing server 108 may also include a receiving unit 202. The receiving unit 202 may be configured to receive data over one or more networks via one or more network protocols. The receiving unit 202 may receive transaction data for a payment transaction from the payment network 106 and/or the parking meter 104. In one embodiment, the transaction data may include at least a specific consumer identifier associated with the consumer 102 involved in the payment transaction, a specific point of sale identifier associated with the parking meter 104 involved in the payment transaction, a transaction amount, and a transaction time and/or date.

In another embodiment, the transaction data may further include rate data. In such an embodiment, the rate data may be provided by the parking meter 104, the consumer 102, and/or the mobile device 110. The rate data may be included in a data field in the authorization request submitted to the payment network 106. In one example, the mobile device 110 may transmit the rate data (e.g., entered into the mobile device 110 by the consumer 102) to the parking meter 104 along with the payment details. The parking meter 104 may then include the rate data in the transaction data transmitted to the processing server 108.

The processing server 108 may further include a processing unit 204. The processing unit 204 may be configured to identify (e.g., calculate) an expiration time and/or date for the parking purchased by the consumer 102 based on the transaction time and/or date and transaction amount included in the received transaction data, and the timing rate for the parking meter 104 or rate data also included in the received transaction data. In instances where the timing rate is used, the processing unit 204 may be configured to identify a parking meter data entry 210 in the meter database 208 related to the parking meter 104 involved in the payment transaction based on the specific point of sale identifier included in the received transaction data. The processing unit 204 may then use the timing data included in the identified parking meter data entry 210.

The processing unit 204 may also identify a specific consumer profile 214 in the consumer database 212 related to the consumer 102 involved in the payment transaction by using the specific consumer identifier included in the received transaction data. The processing unit 204 may generate an alert notification to be provided to the mobile device 110 associated with the device identifier included in the identified specific consumer profile 214.

The processing server 108 may further include a transmitting unit 206. The transmitting unit 206 may be configured to transmit data over one or more networks via one or more network protocols. The transmitting unit 206 may transmit the alert notification to the mobile device 110. In some embodiments, the alert notification may be transmitted to the mobile device 110 via a preferred method of distribution as included in the specific identified consumer profile 214.

### Processes for Providing Parking Meter Alert Notifications

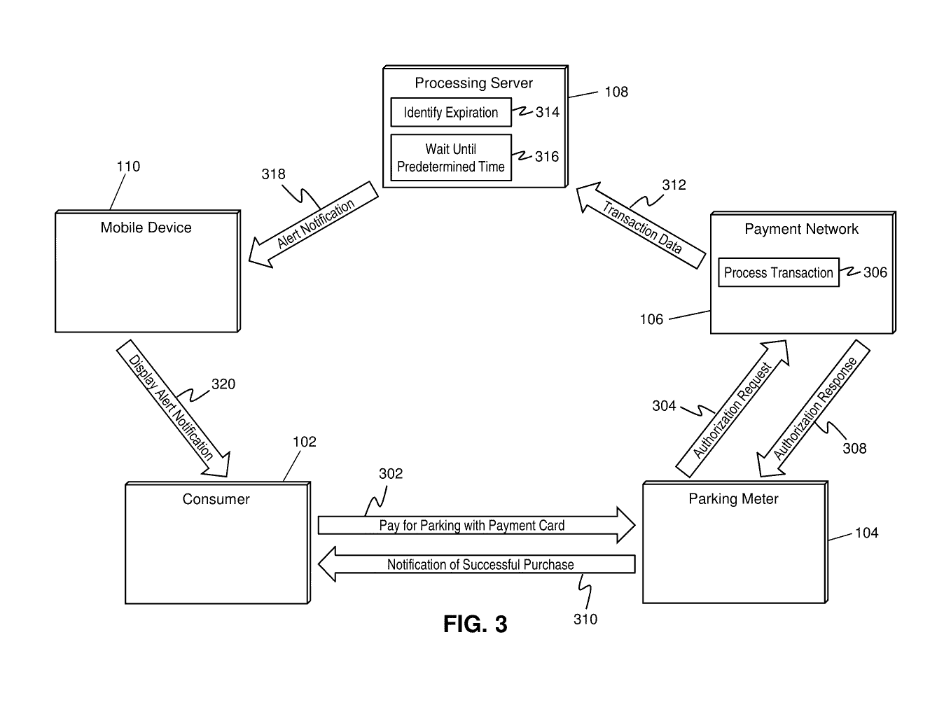

FIG. 3 illustrates a process for providing parking meter alert notifications to the mobile device 110 of a consumer 102 by the processing server 108.

In step 302, the consumer 102 may pay for parking at the parking meter 104 with a payment card. In step 304, the parking meter 104 (e.g., or an acquirer on behalf of the parking meter 104), may transmit an authorization request for the payment transaction to the payment network 106. In one embodiment, the authorization request may include rate data for the parking associated with the payment transaction. In step 306, the payment network 106 may process the payment transaction using methods and systems that will be apparent to persons having skill in the relevant art.

In step 308, the payment network 106 may transmit an authorization response indicating successful processing of the payment transaction back to the parking meter 104. In step 310, the parking meter 104 may notify the consumer 102 of the successful purchase of parking, such as by displaying a notification message on the parking meter 104, furnishing a receipt, or other suitable method.

In step 312, the payment network 106 may transmit transaction data for the payment transaction to the processing server 108. In one embodiment, the transaction data may include a specific consumer identifier associated with the consumer 102, a specific point of sale identifier associated with the parking meter 104, a transaction amount, and a transaction time and/or date. In another embodiment, the transaction data may include at least the specific consumer identifier, the transaction amount, the transaction time and/or date, and rate data.

In step 314, the processing unit 204 of the processing server 108 may identify an expiration time and/or date for the parking based on the transaction time and/or date, the transaction amount, and the rate data and/or timing data. In instances where timing data is used, the processing unit 204 may first identify a parking meter data entry 210 including the specific point of sale identifier included in the received transaction data, and may use the included timing data for identifying the expiration time and/or date.

In step 316, the processing unit 204 may wait until a predetermined time prior to the identified expiration time and/or date. In some instances, the predetermined time may be set by the consumer 102 and included in a consumer profile 214 related to the consumer 102. In other instances, the predetermined time may be set by the processing server 108 and may be based on general consumer preferences, location of the parking meter 104, or other criteria as will be apparent to persons having skill in the relevant art.

In step 318, the processing unit 204 may identify the consumer profile 214 included in the consumer database 212 associated with the consumer 102 using the specific consumer identifier included in the received transaction data, and the transmitting unit 206 may transmit an alert notification to the mobile device 110 associated with the device identifier included in the identified consumer profile 214. In step 320, the mobile device 110 may display the alert notification to the consumer 102. In some embodiments, the alert notification may include the expiration time and/or date and/or the time remaining until the expiration time and/or date. In one embodiment, the alert notification may further include a geographic location of the parking meter 104.

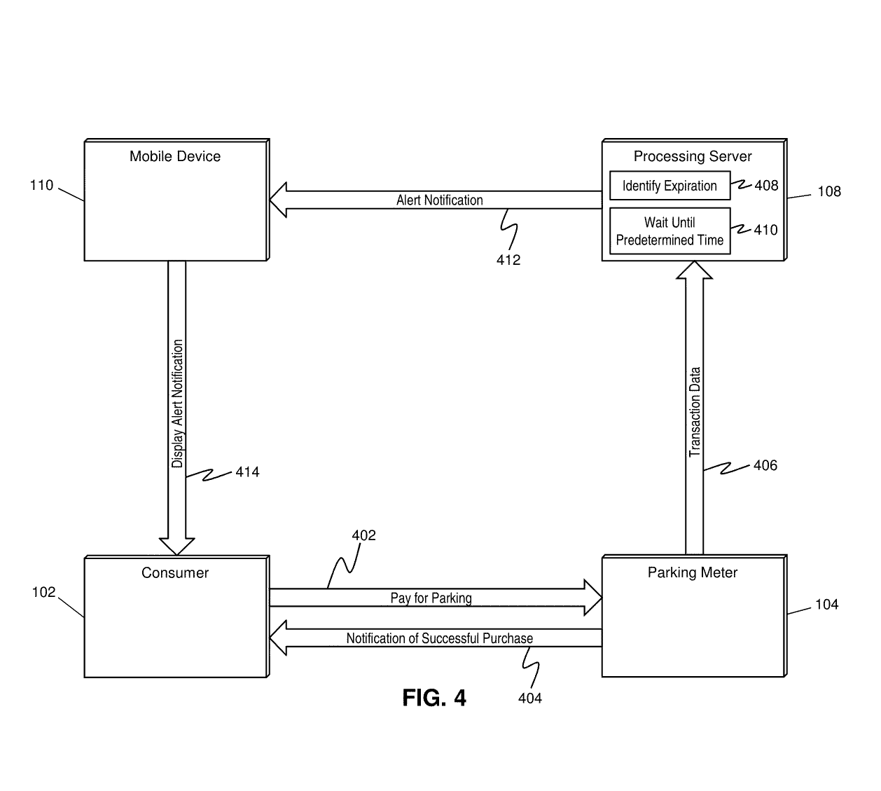

FIG. 4 illustrates an alternative process for providing a parking meter alert notification to the consumer 102 by the processing server 108. In the alternative process, the parking meter 104 may transmit transaction data for the payment transaction related to the parking directly to the processing server 108. In such a process, the payment network 106 may not be required to transmit data to the processing server 108.

In step 402, the consumer 102 may pay for parking at the parking meter 104 with a payment card. The payment card may be encoded with payment details including a consumer identifier associated with the consumer 102. In one embodiment, the consumer 102 may also provide rate data to the parking meter 104 for inclusion in the transaction data, such as via the mobile device 110. For example, the consumer 102 may input rate data into the mobile device 110, which may transmit the rate data along with payment details to the parking meter 104 via near field communication or other suitable communication method and/or protocol.

The parking meter 104 may process the transaction using methods and systems that will be apparent to persons having skill in the relevant art, and, in step 404, transmit a notification of a successful parking purchase to the consumer 102. In step 406, the parking meter 104 may transmit transaction data for the payment transaction to the processing server 108. The transaction data may include the consumer identifier associated with the consumer 102, a transaction amount, a transaction time and/or date, and at least one of: a point of sale identifier associated with the parking meter 104 and rate data (e.g., provided by the consumer 102 and/or the mobile device 110).

In step 408, the processing unit 204 of the processing server 108 may identify the expiration time and/or date for the parking based on the transaction time and/or date, the transaction amount, and the included rate data and/or timing data included in a parking meter data entry 210 including the point of sale identifier associated with the parking meter 104 included in the transaction data. In step 410, the processing unit 204 may wait until the predetermined time prior to the expiration time and/or date. Then, in step 412, the transmitting unit 206 of the processing server 108 may transmit the alert notification to the mobile device 110 associated with the device identifier included in the consumer profile 214 related to the consumer 102 and including the consumer identifier included in the received transaction data. In step 414, the mobile device 110 may display the alert notification to the consumer 102.

### Process for Generating and Distributing a Parking Meter Alert Notification

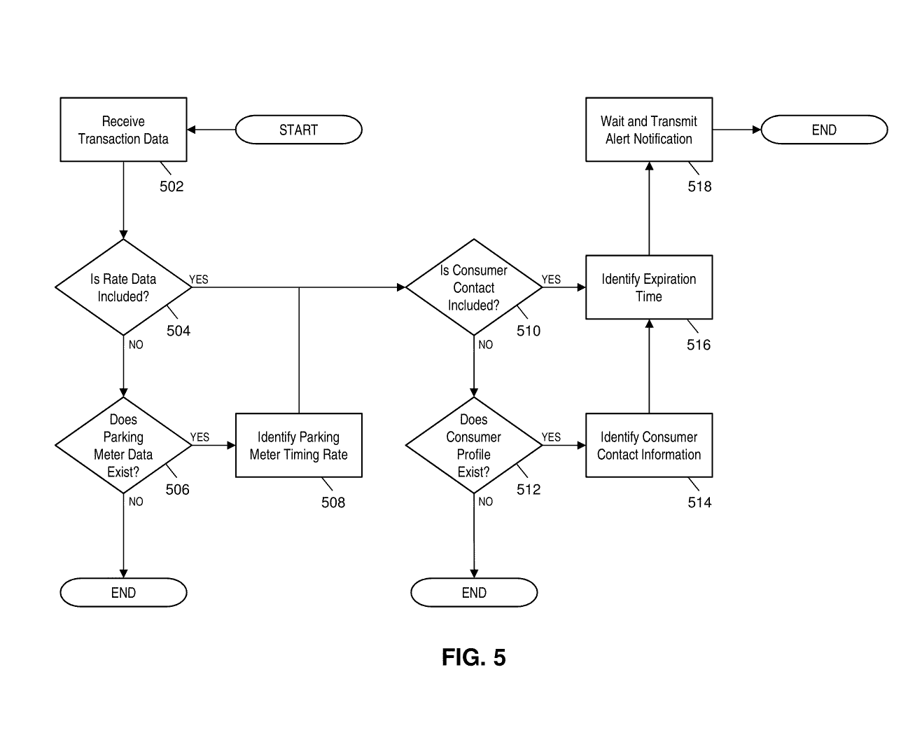

FIG. 5 illustrates a process of the processing server 108 for generating and distributing a parking meter alert notification to the mobile device 110 of the consumer 102 based on transaction data.

In step 502, the receiving unit 202 of the processing server 108 may receive transaction data from the payment network 106 and/or the parking meter 104. The transaction data may include at least a specific consumer identifier, a transaction amount, and transaction time and/or date, and may further include rate data and/or a specific point of sale identifier. In step 504, the processing unit 204 may identify if rate data is included in the received transaction data. If no rate data is included, then, in step 506, the processing unit 204 may determine if there is data stored for the parking meter 104 involved in the transaction.

Determining if there is data stored for the parking meter 104 may include identifying, in the meter database 208, if there is a parking meter data entry 210 where the included point of sale identifier corresponds to the specific point of sale identifier included in the received transaction data. If no such parking meter data entry 210 is found, then the processing server 108 has no information regarding the rate of the parking meter 104, and thus may be unable to provide an alert notification. In such an instance, then the process may be finished.

If a parking meter data entry 210 related to the parking meter 104 is identified, then, in step 508, the processing unit 204 may identify the parking meter timing rate included in the parking meter data entry 210. Once the timing rate is identified, or if the transaction data included the rate data (e.g., as identified in step 504), then, in step 510, the processing unit 204 may identify if the transaction data further includes contact information for the consumer 102. For example, the transaction data may include a device identifier for the mobile device 110, such as via use of a wallet application program to provide payment details for the payment transaction, or being provided by the consumer 102 to the parking meter 104 via an input device, etc.

If there is no contact information for the consumer 102 included in the transaction data, then, in step 512, the processing unit 204 may determine if a consumer profile 214 related to the consumer 102 exists, by identifying if there is a consumer profile 214 in the consumer database 212 where the included consumer identifier corresponds to the specific consumer identifier included in the received transaction data. If no such consumer profile 214 is found, then the processing server 108 may have no method for distributing an alert notification to the consumer 102, and thus the process may end.

If a consumer profile 214 related to the consumer 102 is identified, then, in step 514, the processing unit 204 may identify contact information included in the consumer profile 214. The contact information may include a device identifier associated with a mobile device 110 associated with the consumer 102, such as a media access control address, phone number, e-mail address, or other suitable value as will be apparent to persons having skill in the relevant art. In step 516, the processing unit 204 may identify an expiration time and/or date for the purchased parking based on the transaction amount, transaction time and/or date, and the rate data or timing data.

In step 518, the processing server 108 may wait until a predetermined time prior to the expiration time and/or date and then the transmitting unit 206 may transmit an alert notification to the mobile device 110 and/or consumer 102 via the contact information included in the received transaction data or the identified consumer profile 214. In some instances, the parking meter alert notification may include the identified expiration time and/or date and/or a geographic location of the parking meter 104, such as a geographic location identified in the parking meter data entry 210 related to the parking meter 104 and identified in step 506.

### First Exemplary Method for Providing Parking Meter Alert Notifications

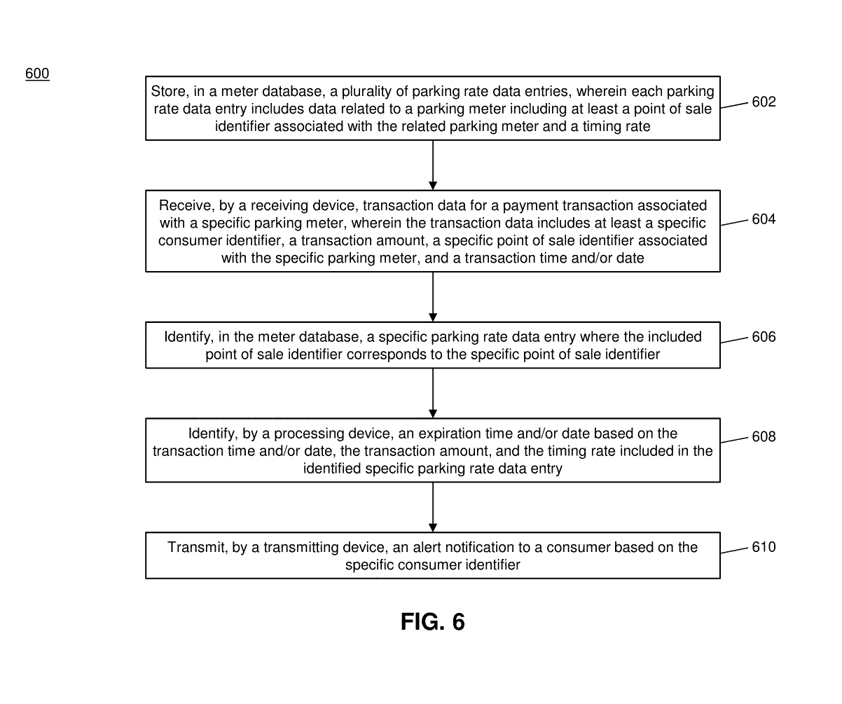

FIG. 6 illustrates a method 600 for providing parking meter alert notifications to a consumer 102 based on transaction data.

In step 602, a plurality of parking rate data entries (e.g., parking meter data entries 210) may be stored in a meter database (e.g., the meter database 208), wherein each parking rate data entry 210 includes data related to a parking meter (e.g., the parking meter 104) including at least a point of sale identifier associated with the related parking meter and a timing rate. In one embodiment, the timing rate may be based on at least one of: communication from the related parking meter 104, consumer input, payment pattern recognition, and consumer crowdsourcing. In some embodiments, the point of sale identifier may be a geographic location associated with the related parking meter 104.

In step 604, transaction data for a payment transaction associated with a specific parking meter 104 may be received by a receiving device (e.g., the receiving unit 202), wherein the transaction data includes at least a specific consumer identifier, a transaction amount, a specific point of sale identifier associated with the specific parking meter 104, and a transaction time and/or date. In step 606, a specific parking rate data entry 210 may be identified, in the meter database 208, where the included point of sale identifier corresponds to the specific point of sale identifier. In step 608, an expiration time and/or date may be identified, by a processing device (e.g., the processing unit 204), based on the transaction time and/or date, the transaction amount, and the timing rate included in the identified specific parking rate data entry 210.

In step 610, an alert notification may be transmitted, by a transmitting device (e.g., the transmitting unit 206), to a consumer (e.g., the consumer 102), based on the specific consumer identifier. In one embodiment, the alert notification may include the identified expiration time and/or date. In some embodiments, the alert notification may be transmitted to the consumer 102 at a predetermined time prior to the identified expiration time and/or date. In one embodiment, the specific consumer identifier may be at least one of: an e-mail address, phone number, media access control address, and an Internet protocol address, and the alert notification may be transmitted to a mobile communication device (e.g., the mobile device 110) associated with the specific consumer identifier. In one embodiment, each parking rate data entry 210 may further include a geographic location associated with the related parking meter 104, and the alert notification may include the geographic location included in the specific parking rate data entry 210.

In one embodiment, the method 600 may further include: storing, in a consumer database (e.g., the consumer database 212), a plurality of consumer profiles (e.g., consumer profiles 214), wherein each consumer profile 214 includes data related to a consumer (e.g., the consumer 102) including a consumer identifier, a device identifier, and a preferred method of communication; and identifying, in the consumer database 212, a specific consumer profile 214 where the included consumer identifier corresponds to the specific consumer identifier. In a further embodiment, transmitting the alert notification to the consumer 102 may include transmitting, by the transmitting device 206, the alert notification to a communication device (e.g., the mobile device 110) associated with the device identifier included in the specific consumer profile 214 via the included preferred method of communication. In an even further embodiment, the device identifier may be at least one of: a media access control address, an Internet protocol address, a registration number, serial number, username, phone number, and e-mail address. In another further embodiment, the preferred method of communication may be at least one of: e-mail, short message service message, multimedia message service message, telephone, and an application program.

### Second Exemplary Method for Providing Parking Meter Alert Notifications

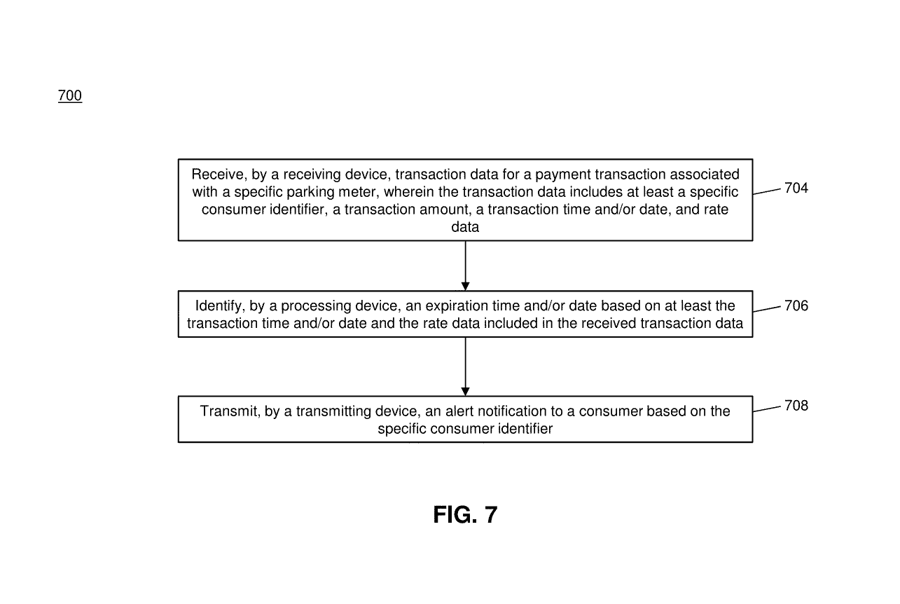

FIG. 7 illustrates an alternative method 700 for providing parking meter alert notifications to a consumer 102 based on transaction data.

In step 702, transaction data for a payment transaction associated with a specific parking meter (e.g., the parking meter 104) may be received by a receiving device (e.g., the receiving unit 202), wherein the transaction data includes at least a specific consumer identifier, a transaction amount, a transaction time and/or date, and rate data. In one embodiment, the transaction data may be included in an authorization request for the payment transaction, and the rate data may be included in a data field in the authorization request. In a further embodiment, the rate data may be provided by the specific parking meter 104. In another further embodiment, the rate data may be provided by a consumer during provision of payment information for the payment transaction. In an even further embodiment, the providing of the date data may be performed via near field communication.

In step 704, an expiration time and/or date may be identified, by a processing device (e.g., the processing unit 204), based on at least the transaction time and/or date and the rate data included in the received transaction data. In step 706, an alert notification may be transmitted, by a transmitting device (e.g., the transmitting unit 206), to a consumer (e.g., the consumer 102) based on the specific consumer identifier. In one embodiment, the alert notification may include the identified expiration time and/or date. In some embodiments, the alert notification may be transmitted to the consumer 102 at a predetermined time prior to the identified expiration time and/or date. In one embodiment, the specific consumer identifier may be at least one of: an e-mail address, phone number, media access control address, and Internet protocol address, and the alert notification may be transmitted to a mobile communication device (e.g., the mobile device 110) associated with the specific consumer identifier.

In one embodiment, the method 700 may further include: storing, in a consumer database (e.g., the consumer database 212), a plurality of consumer profiles (e.g., consumer profiles 214), wherein each consumer profile 214 includes data related to a consumer (e.g., the consumer 102) including a consumer identifier, a device identifier, and a preferred method of communication; and identifying, in the consumer database 212, a specific consumer profile 214 where the included consumer identifier corresponds to the specific consumer identifier. In a further embodiment, transmitting the alert notification to the consumer 102 may include transmitting, by the transmitting device 206, the alert notification to a communication device (e.g., the mobile device 110) associated with the device identifier included in the specific consumer profile 214 via the included preferred method of communication. In an even further embodiment, the device identifier may be at least one of: a media access control address, an Internet protocol address, a registration number, serial number, username, phone number, and e-mail address. In another further embodiment, the preferred method of communication may be at least one of: e-mail, short message service message, multimedia message service message, telephone, and an application program.

In one embodiment, the method 700 my further include: storing, in a meter database (e.g., the meter database 208), a plurality of parking rate data entries (e.g., parking meter data entries 210), wherein each parking rate data entry 210 includes data related to a parking meter 104 including at least a point of sale identifier and a geographic location associated with the related parking meter; and identifying, in the meter database 208, a specific parking rate data entry 210 where the included point of sale identifier corresponds to the specific point of sale identifier, wherein the alert notification includes the geographic location included in the specific parking rate data entry 210.

### Computer System Architecture

FIG. 8 illustrates a computer system 800 in which embodiments of the present disclosure, or portions thereof, may be implemented as computer-readable code. For example, the processing server 108 and the computing device 106 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communications infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive or universal serial bus port, the removable storage unit 818 may be a floppy disk or portable flash drive, respectively. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

The computer system 800 may further include a display interface 802. The display interface 802 may be configured to allow data to be transferred between the computer system 800 and external display 830. Exemplary display interfaces 802 may include high-definition multimedia interface (HDMI), digital visual interface (DVI), video graphics array (VGA), etc. The display 830 may be any suitable type of display for displaying data transmitted via the display interface 802 of the computer system 800, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 808 and secondary memory 810, which may be memory semiconductors (e.g., DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 3-7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

Techniques consistent with the present disclosure provide, among other features, systems and methods for providing parking meter alert notifications. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

1-10. (canceled)

11. A method for providing parking meter alert notifications, comprising:
receiving, by a receiving device, transaction data for a payment transaction associated with a specific parking meter, wherein the transaction data includes at least a specific consumer identifier, a transaction amount, and a transaction time and/or date;
receiving, by the receiving device, rate data;
identifying, by a processing device, an expiration time and/or date based on at least the transaction time and/or date, the rate data, and the transaction amount included in the received transaction data; and
transmitting, by a transmitting device, an alert notification to a consumer based on the specific consumer identifier.

12. The method of claim 11, wherein the alert notification includes the identified expiration time and/or date.

13. The method of claim 11, wherein the alert notification is transmitted to the consumer at a predetermined time prior to the identified expiration time and/or date.

14. The method of claim 11, wherein
the specific consumer identifier is at least one of: an e-mail address, phone number, media access control address, and internet protocol address, and
the alert notification is transmitted to a mobile communication device associated with the specific consumer identifier.

15. The method of claim 11, further comprising:
storing, in a consumer database, a plurality of consumer profiles, wherein each consumer profile includes data related to a consumer including at least a consumer identifier, a device identifier, and a preferred method of communication; and
identifying, in the consumer database, a specific consumer profile where the included consumer identifier corresponds to the specific consumer identifier, wherein
transmitting the alert notification to the consumer includes transmitting, by the transmitting device, the alert notification to a communication device associated with the device identifier included in the identified specific consumer profile via the included preferred method of communication.

16. (canceled)

17. (canceled)

18. The method of claim 11, wherein the transaction data is included in an authorization request for the payment transaction, and wherein the rate data is included in a data field in the authorization request.

19. (canceled)

20. The method of claim 18, wherein the rate data is provided by the consumer during provision of payment information for the payment transaction.

21. The method of claim 20, wherein the providing of rate data is performed via near field communication.

22. The method of claim 11, wherein the transaction data further includes a specific point of sale identifier, and the method further comprises:
storing, in a meter database, a plurality of parking rate data entries, wherein each parking rate data entry includes data related to a parking meter including at least a point of sale identifier and a geographic location associated with the related parking meter; and
identifying, in the meter database, a specific parking rate data entry where the included point of sale identifier corresponds to the specific point of sale identifier, wherein
the alert notification includes the geographic location included in the specific parking rate data entry.

23-32. (canceled)

33. A system for providing parking meter alert notifications, comprising:
a receiving device configured to receive transaction data for a payment transaction associated with a specific parking meter, wherein the transaction data includes at least a specific consumer identifier, a transaction amount, a transaction time and/or date, and rate data;
a processing device configured to identify an expiration time and/or date based on at least the transaction time and/or date, the rate data, and the transaction amount included in the received transaction data; and
a transmitting device configured to transmit an alert notification to a consumer based on the specific consumer identifier.

34. The system of claim 33, wherein the alert notification includes the identified expiration time and/or date.

35. The system of claim 33, wherein the alert notification is transmitted to the consumer at a predetermined time prior to the identified expiration time and/or date.

36. The system of claim 33, wherein
the specific consumer identifier is at least one of: an e-mail address, phone number, media access control address, and internet protocol address, and
the transmitting device is configured to transmit the alert notification to a mobile communication device associated with the specific consumer identifier.

37. The system of claim 33, further comprising:
a consumer database configured to store a plurality of consumer profiles, wherein each consumer profile includes data related to a consumer including at least a consumer identifier, a device identifier, and a preferred method of communication, wherein
the processing device is further configured to identify, in the consumer database, a specific consumer profile where the included consumer identifier corresponds to the specific consumer identifier, and
the transmitting device is configured to transmit the alert notification to a communication device associated with the device identifier included in the identified specific consumer profile via the included preferred method of communication.

38. (canceled)

39. (canceled)

40. The system of claim 33, wherein the transaction data is included in an authorization request for the payment transaction, and wherein the rate data is included in a data field in the authorization request.

41. (canceled)

42. The system of claim 33, wherein the rate data is provided by the consumer during provision of payment information for the payment transaction.

43. The system of claim 33, wherein the providing of rate data is performed via near field communication.

44. The system of claim 33, wherein the transaction data further includes a specific point of sale identifier, and the system further comprises:
a meter database configured to store a plurality of parking rate data entries, wherein each parking rate data entry includes data related to a parking meter including at least a point of sale identifier and a geographic location associated with the related parking meter, wherein
the processing device is further configured to identify, in the meter database, a specific parking rate data entry where the included point of sale identifier corresponds to the specific point of sale identifier, and
the alert notification includes the geographic location included in the specific parking rate data entry.

45. The method of claim 11, wherein the transaction data further includes a specific point of sale identifier, and the method further comprises:
storing, in a meter database, a plurality of parking rate data entries, wherein each parking rate data entry includes data related to a parking meter including at least a point of sale identifier and a timing rate associated with the related parking meter; and
identifying, in the meter database, a specific parking rate data entry where the included point of sale identifier corresponds to the specific point of sale identifier, wherein
the received rate data is the timing rate included in the identified specific parking rate data entry.

46. The system of claim 33, wherein the transaction data further includes a specific point of sale identifier, and the system further comprises:
a meter database configured to store a plurality of parking rate data entries, wherein each parking rate data entry includes data related to a parking meter including at least a point of sale identifier and a timing rate associated with the related parking meter, wherein
the processing device is further configured to identify, in the meter database, a specific parking rate data entry where the included point of sale identifier corresponds to the specific point of sale identifier, and
the received rate data is the timing rate included in the identified specific parking rate data entry.
